(19) United States
(12) Patent Application Publication
(10) Pub. No.: US 2023/0124781 A1
(43) Pub. Date: Apr. 20, 2023

(54) VEHICLE TO VEHICLE COMMUNICATION USING RADAR

(71) Applicant: GM Cruise Holdings LLC, San Francisco, CA (US)

(72) Inventors: Daniel Flores Tapia, Fairfield, CA (US); Jack Stepanian, San Francisco, CA (US)

(21) Appl. No.: 17/505,080

(22) Filed: Oct. 19, 2021

(51) Int. Cl. G01S 7/00; H04W 4/40; H04L 25/02; G01S 13/931

(52) U.S. Cl. CPC G01S 7/006; H04W 4/40; H04L 25/02; G01S 13/931

(57) ABSTRACT

The subject disclosure relates to techniques for enabling vehicle to everything communication. A radar sensor of the disclosed technology can include at least one memory and at least one processor coupled to the at least one memory. The at least one processor can be configured to receive a radar signal having radar data and message data, disaggregate the radar data and the message data using a heterodyne mixer, and provide the radar data to a radar signal processor via a waveform correlator.

### BACKGROUND

### 1. Technical Field

The subject technology provides solutions for improving vehicle to vehicle communication and in particular for enabling vehicle-to-everything (V2X) communications between vehicles using radar sensors.

### 2. Introduction

Currently, vehicle to everything (V2X) communication is reliant on short range communication devices in the cellular communication bands. This technology has range limitations, spectrum congestion, specialized hardware, and provider costs.

### BRIEF DESCRIPTION OF THE DRAWINGS

FIG. 1 illustrates an example environment in which a radar-based V2X communication process of the disclosed technology may be implemented.

FIG. 2 illustrates a block diagram of an example radar transceiver according to an example of the instant disclosure.

FIG. 3 is a flowchart of a method for performing vehicle to everything communication according to an example of the instant disclosure.

FIG. 4 illustrates environment that includes an autonomous vehicle in communication with a computing system.

FIG. 5 shows an example of a processor-based system that may be used for implementing certain aspects of the present technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Current vehicle to X (V2X) communication, where X includes but is not limited to infrastructure and other vehicles, typically uses short range communication devices in the cellular communication bands. These cellular communication bands often have range limitations, spectrum congestions, and bandwidth limitations, among other limitations. For example, the current expected range of V2X systems at conventional 5.9 gigahertz (GHz) bands is approximately 50 meters. As another example, the typical allocated bandwidth limitations for current V2X communication (e.g., on a conventional 5.9 GHz band) is approximately 75 megahertz (MHz). These limitations restrict and/or prevent the transmission of high-bandwidth messages, which ultimately reduces the amount of information that can be provided to infrastructure and other vehicles. Thus, there is a need in the art for an efficient system and process for enabling high bandwidth message data to be sent to and from vehicles and infrastructure.

Accordingly, aspects of the present technology address the limitations of conventional V2X communication systems by providing solutions in which vehicle radar sensors can be configured to send and receive data. More specifically, radar transceivers of radar sensors can be modified to mix complex message data with radar data in a radar signal. The radar signal can be transmitted as a radar waveform on specified bands. For example, the radar waveform can be transmitted over an automotive radar RF band (e.g., 77-81 GHz), which would avoid the spectrum congestion on other communication bands and provide 4 GHz of bandwidth. Current radar transceivers, however, are not designed for this. More specifically, radar sensors are not configured to mix message data into a radar signal, or send the radar signal having the message data mixed therein. Consequently, radar sensors receiving the radar signal are not configured to disaggregate the radar data from the message data. Accordingly, aspects of the present technology similarly address the limitations of conventional radar sensors by including various other modules on both the sending transceiver and the receiving transceiver to enable the sending and receiving of message data mixed into radar signals.

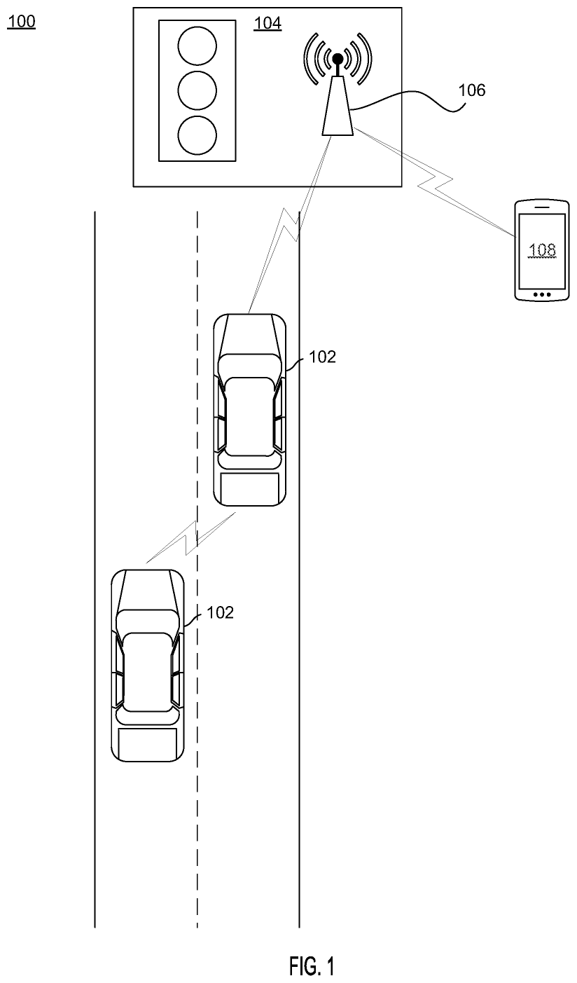

FIG. 1 illustrates an environment 100 in which a radar-based V2X communication process of the disclosed technology may be implemented. More specifically, environment 100 can have vehicles 102 and infrastructure 104. Vehicles 102 can have radar sensors configured to have transceivers that enable communication with other vehicles 102 and/or with infrastructure 104. For example, infrastructure 104 (e.g., a traffic light) can have a radar transceiver 106 configured to communicate with vehicles 102. Additionally, mobile devices 108 (e.g., mobile devices of pedestrians) can also be configured to communicate with radar transceivers of vehicles 102 and/or infrastructure 104 (e.g., via radar transceivers 106). For example, vehicles 102 can send a radar signal including message data to infrastructure 104, which is received by radar transceiver 106. Infrastructure 104 can then forward the message data to mobile devices 108. As yet another example, infrastructure 104, such as a traffic light or light post, may send a signal with message data to vehicles 102 to warn vehicles 102 of an incoming emergency vehicle.

More specifically, the radar transceivers are configured with novel modules to send and/or receive radar signals having both radar data and message data to and/or from other transceivers. On a transmitting end, the radar signals can be broadcasted (e.g., via a transmitting antenna of a transmitting radar transceiver) on radio frequencies (RF) including, but not limited to, an automotive radar RF band (e.g., 77-81 GHz). The automotive radar RF band can have a pre-allocated bandwidth. For example, the automotive radar RF band can have a pre-allocated bandwidth of up to 4 GHz (e.g., 77-81 GHz). In some embodiments, the allocation of bandwidth can be variable based on a speed of a sending transceiver. For example, a vehicle 102 travelling at a lower speed can send a radar signal having a comparatively larger allocation of bandwidth to accommodate a higher resolution of slow and/or high density of objects. More specifically, in urban environments, vehicles tend to operate at a slower speed due to high density of objects (e.g., pedestrians, other vehicles, etc. detected by the vehicle). Thus, messages from these slower vehicles need more bandwidth to include the higher number of objects. Accordingly, the radar transceiver can send a radar signal with a higher allocation of bandwidth to include all the data of objects. In other words, the radar transceiver can dynamically allocate bandwidth for the radar signal based on a speed of the sending radar transceiver and/or a vehicle associated with the sending radar transceiver.

On a receiving end, the radar signals can be received (e.g., via a receiving antenna) over the automotive radar RF band. The receiving radar transceiver can receive the radar signal and disaggregate the radar signal into radar data and message data. As will be discussed in more detail below, the receiving radar transceiver can also process the radar data and the message data. In some embodiments, the processing of the radar data and the message data can occur simultaneously and/or in parallel.

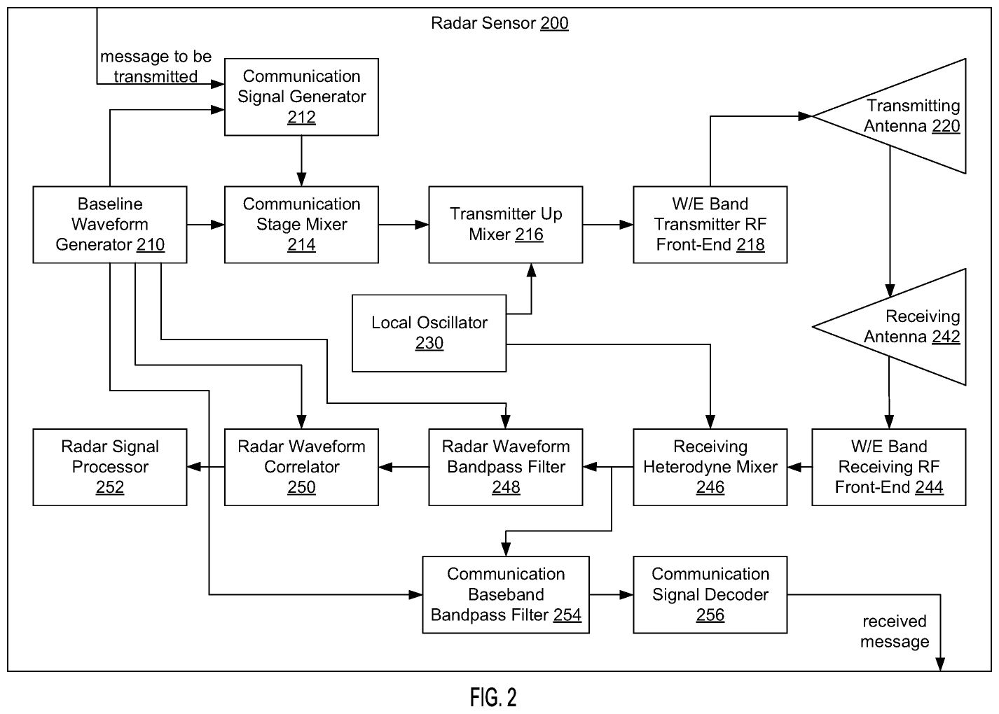

FIG. 2 illustrates a block diagram of an example radar sensor 200 that is configured to transmit and receive mixed mode radar signals, i.e., that contain radar sensor information as well as communication/message payload data, such as a radar transceiver on vehicle 102 and/or radar transceivers 106 discussed above with respect to FIG. 1. Radar sensor 200 can include a communication signal generator 212, a communication stage mixer 214, a transmitter up mixer 216, a transmitter RF front end 218, and a transmitting antenna 220. Radar sensor 200 can also include a radar signal processor 252, a radar waveform correlator 250, a radar waveform bandpass filter 248, communication baseband bandpass filter 254, a communication signal decoder 256, a heterodyne mixer 246, a receiving RF front end 244, and a receiving antenna 242. Additionally, radar sensor 200 can include a baseline waveform generator 210 and a local oscillator 230.

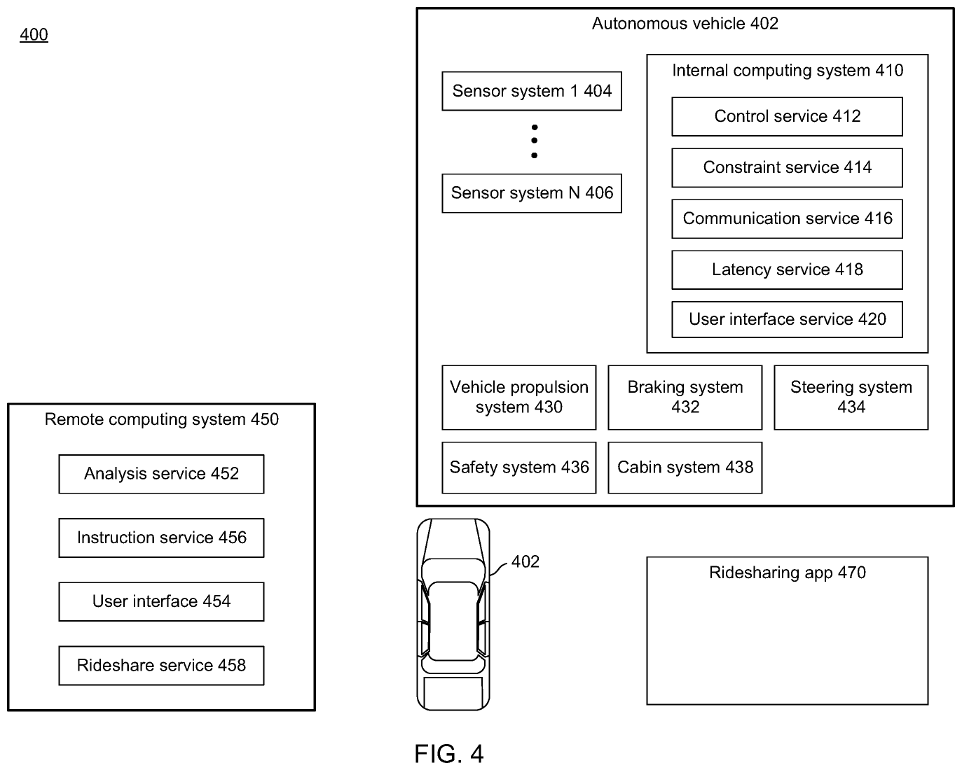

Communication signal generator 212 is configured to generate electronic signals for example, that represent message data. More specifically, it can determine that a message is to be transmitted and generate a communication signal having message data for the message. In some embodiments, communication signal generator 212 can determine that a message is to be transmitted based on receiving the message. For example, in an autonomous vehicle (e.g., autonomous vehicle 402 described below with respect to FIG. 4), communication signal generator 212 can receive the message from an internal computing system, e.g., internal computing system 410, described below with respect to FIG. 4). In some embodiments, communication signal generator 212 can be configured to encode the message data using a V2X communication protocol. In other words, communication signal generator 212 is configured to receive a message to transmit and encode the message using a V2X communication protocol.

Baseline waveform generator 210 determines which band and how much bandwidth will be used for a radar signal or radar waveform. Baseline waveform generator 210 then generates a radar signal with one or more bands and an allocated amount of bandwidth. Baseline waveform generator 210 can dynamically allocate the one or more bands and the allocated amount of bandwidth based on a use case of the radar signal. For example, baseline waveform generator 210 can be on board a vehicle. Thus, baseline waveform generator 210 can identify a vehicle use case of the radar signal and dynamically allocate the bands and the amount of bandwidth based on a speed of the vehicle. These bands and the allocated bandwidth can be then used by communication stage mixer 214 to incorporate message data.

Communication stage mixer 214 can mix in message data received from communication signal generator 212 into the radar waveform received from baseline waveform generator 210. Communication stage mixer 214 is configured to aggregate a radar signal having radar data and a communication signal having message data into a radar signal having both radar data and message data. Additionally, communication stage mixer 214 can dynamically allocate a first set of bands to the radar data and remaining set of bands to the message data. In some embodiments, the communication stage mixer 214 may be on a vehicle. In these embodiments, the communication stage mixer 214 can dynamically allocate the bands, such that when the vehicle is travelling faster, more bands are allocated to communications (e.g., message data) because the vehicle is likely in a less target-rich environment. It is also considered that less bandwidth can be allocated for a longer duration to improve range performance and that more bandwidth can be allocated to communications for shorter durations to improve resolution of a target rich environment (e.g., urban environments having many pedestrians, vehicles, etc.). For example, a vehicle travelling at a low speed in an urban environment may permit communication stage mixer 214 to allocate 2 GHz of bandwidth to radar data. Assuming usage of the full automotive radar RF band (e.g., 77-81 GHz), there is a remaining 2 GHz of bandwidth to transmit messages, which is almost four times as much bandwidth as conventional V2X applications. As another example, the vehicle is now travelling more quickly and less targets or objects, so communication stage mixer 214 can allocate less bandwidth to radar, such as 1 GHz of bandwidth. Thus, there is a remaining 3 GHz of bandwidth to transmit complex messages.

Transmitter up mixer 216 is configured to receive the radar signal from communication stage mixer 214 and change the frequency of the radar signal for transmission. More specifically, transmitter up mixer 216 is configured to modulate the radar signal to an appropriate RF band (e.g., automotive radar RF band). The frequency change or heterodyning can be performed in conjunction with and/or based on local oscillator 230.

Local oscillator 230 is configured to be used with a mixer to change a frequency of a signal, such as the radar signal. Local oscillator 230 can thus be configured to heterodyne the communication signal and radar data into the radar signal, which can then be transmitted via transmitting antenna 220. Additionally, local oscillator 230 can be used with heterodyne mixer 246 to change the frequency of the received radar signal and facilitate disaggregation of the received radar signal into a radar signal having the radar data and a communication signal having the message data.

Transmitter RF front end 218 is composed of circuitry to enable transmission of radar signals and radar waveforms. Transmitter RF front end 218 can be configured to transmit W and/or E bands (e.g., 75 to 115 GHz and/or 60 to 90 GHz).

Transmitting antenna 220 is configured to transmit a signal. More specifically, transmitting antenna 220 is configured to transmit a radar signal and/or radar waveform that is received from transmitter RF front end 218.

Receiving antenna 242 is configured to receive a signal. More specifically, receiving antenna 242 is configured to receive a radar signal and/or radar waveform from a transmitting antenna (e.g., transmitting antenna 220) and pass the radar signal or radar waveform to receiving RF front end 244.

Receiving RF front end 244 is composed of circuitry to enable receipt of radar signals and radar waveforms. Receiving RF front end 244 can be configured to receive W and/or E bands (e.g., 75 to 115 GHz and/or 60 to 90 GHz).

Heterodyne mixer 246 is configured to change the radar signal into a frequency that can be more easily managed. In other words, heterodyne mixer 246 can convert the radar signal down from the transmitted band (e.g., the automotive radar RF band) and filter harmonics that may be associated with the conversion, while retaining the message data. In some embodiments, heterodyne mixer 246 can disaggregate the radar signal into several frequency bands. In other words, heterodyne mixer 246 can disaggregate the radar signal, such that the radar data is disaggregated into radar frequency bands and the message data is disaggregated into communication bands. In some embodiments, the disaggregation is performed in conjunction with and/or based on local oscillator 230. Heterodyne mixer 246 can then provide the disaggregated radar data to radar waveform bandpass filter 248 and provide the disaggregated message data to communication baseband bandpass filter 254.

Radar waveform bandpass filter 248 is configured to receive radar signals and filter irrelevant frequencies (e.g., communication frequencies having message data) out. In some embodiments, radar waveform bandpass filter 248 can receive information from baseline waveform generator 210 that facilitates identifying frequencies having radar data and frequencies having message data. Radar waveform bandpass filter 248 is also configured to send the filtered radar signals to radar waveform correlator 250.

Radar waveform correlator 250 is configured to measure a delay between when the radar signal was transmitted and received to determine the range of the targets identified in the radar signal. In some embodiments, radar waveform correlator 250 can receive information from baseline waveform generator 210 that facilitates measuring the delay.

Radar signal processor 252 is configured to process the radar signal and radar data. More specifically, radar signal processor 252 can determine properties of objects included in the radar signal. For example, radar signal processor 252 can separate targets from clutter on the basis of Doppler content and amplitude characteristics.

Communication baseband bandpass filter 254 is configured to receive communication signals and filter irrelevant frequencies (e.g., radar frequencies having radar data) out. In some embodiments, communication baseband bandpass filter 254 can receive information from baseline waveform generator 210 that facilitates identifying frequencies having radar data and frequencies having message data. Communication baseband bandpass filter 254 is also configured to send the filtered communication signals to communication signal decoder 256.

Communication signal decoder 256 is configured to convert the communication signal into a format that can be understood by a computing device (e.g., autonomous vehicle 402 and/or internal computing system 410 as will be discussed below with respect to FIG. 4, a remote computing system of infrastructure, etc.). In other words, communication signal decoder 256 can decode the filtered communication signal to access the message data.

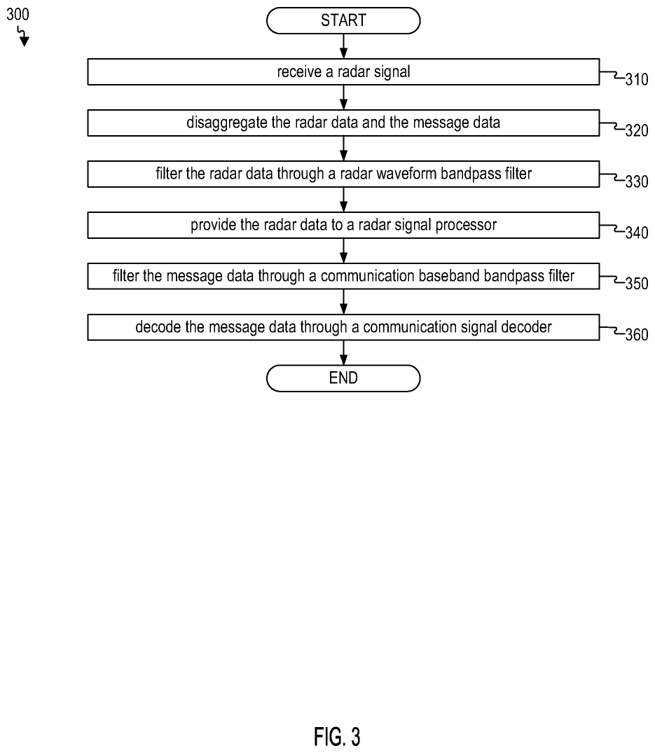

FIG. 3 illustrates an example method 300 for performing vehicle to everything communication. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method includes receiving a radar signal at step 310. For example, the radar transceiver illustrated in FIG. 2 may receive a radar signal, e.g., from a radar sensor that is associated with another vehicle. In some embodiments, the radar signal can include message data that has been encoded using a Vehicle-to-Everything (V2X) communication protocol. In some embodiments, the radar signal includes an allocated amount of bandwidth that is dynamically determined and/or allocated by a speed of a vehicle sending the radar signal. In some embodiments, the radar signal is received on an automotive radar radio frequency (RF) band.

According to some embodiments, the method includes disaggregating the radar data and the message data. As discussed above, radar signal/message data disaggregation can be performed using one or more mixers and/or filters, such as using a heterodyne mixer at step 320. For example, the radar transceiver illustrated in FIG. 2 may disaggregate the radar data and the message data using a heterodyne mixer 246.

According to some embodiments, the method includes filtering the radar data through a radar waveform bandpass filter at step 330. For example, the radar transceiver illustrated in FIG. 2 may filter the radar data through a radar waveform bandpass filter.

According to some embodiments, the method includes providing the radar data to a radar signal processor via a waveform correlator at step 340. For example, the radar transceiver illustrated in FIG. 2 may provide the radar data to a radar signal processor via a waveform correlator.

According to some embodiments, the method includes filtering the message data through a communication baseband bandpass filter at step 350. For example, the radar transceiver illustrated in FIG. 2 may filter the message data through a communication baseband bandpass filter.

According to some embodiments, the method includes decoding the message data through a communication signal decoder at step 360. For example, the radar transceiver illustrated in FIG. 2 may decode the message data through a communication signal decoder.

FIG. 4 illustrates environment 400 that includes an autonomous vehicle 402 in communication with a computing system 450.

The autonomous vehicle 402 can navigate about roadways without a human driver based upon sensor signals output by sensor systems 404-406 of the autonomous vehicle 402. The autonomous vehicle 402 includes a plurality of sensor systems 404-406 (a first sensor system 404 through an Nth sensor system 406). The sensor systems 404-406 are of different types and are arranged about the autonomous vehicle 402. For example, the first sensor system 404 may be a camera sensor system and the Nth sensor system 406 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 402 further includes several mechanical systems that are used to effectuate appropriate motion of the autonomous vehicle 402. For instance, the mechanical systems can include but are not limited to, a vehicle propulsion system 430, a braking system 432, and a steering system 434. The vehicle propulsion system 430 may include an electric motor, an internal combustion engine, or both. The braking system 432 can include an engine brake, brake pads, actuators, and/or any other suitable componentry that is configured to assist in decelerating the autonomous vehicle 402. The steering system 434 includes suitable componentry that is configured to control the direction of movement of the autonomous vehicle 402 during navigation.

The autonomous vehicle 402 further includes a safety system 436 that can include various lights and signal indicators, parking brake, airbags, etc. The autonomous vehicle 402 further includes a cabin system 438 that can include cabin temperature control systems, in-cabin entertainment systems, etc.

The autonomous vehicle 402 additionally comprises an internal computing system 410 that is in communication with the sensor systems 404-406 and the mechanical systems 430, 432, 434. The internal computing system includes at least one processor and at least one memory having computer-executable instructions that are executed by the processor. The computer-executable instructions can make up one or more services responsible for controlling the autonomous vehicle 402, communicating with remote computing system 450, receiving inputs from passengers or human co-pilots, logging metrics regarding data collected by sensor systems 404-406 and human co-pilots, etc.

The internal computing system 410 can include a control service 412 that is configured to control operation of the vehicle propulsion system 430, the braking system 432, the steering system 434, the safety system 436, and the cabin system 438. The control service 412 receives sensor signals from the sensor systems 404-406 as well communicates with other services of the internal computing system 410 to effectuate operation of the autonomous vehicle 402. In some embodiments, control service 412 may carry out operations in concert one or more other systems of autonomous vehicle 402.

The internal computing system 410 can also include a constraint service 414 to facilitate safe propulsion of the autonomous vehicle 402. The constraint service 414 includes instructions for activating a constraint based on a rule-based restriction upon operation of the autonomous vehicle 402. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 412.

The internal computing system 410 can also include a communication service 416. The communication service can include both software and hardware elements for transmitting and receiving signals from/to the remote computing system 450. The communication service 416 is configured to transmit information wirelessly over a network, for example, through an antenna array that provides personal cellular (long-term evolution (LTE), 3G, 5G, etc.) communication.

In some embodiments, one or more services of the internal computing system 410 are configured to send and receive communications to remote computing system 450 for such reasons as reporting data for training and evaluating machine learning algorithms, requesting assistance from remoting computing system or a human operator via remote computing system, software service updates, ridesharing pickup and drop off instructions etc.

The internal computing system 410 can also include a latency service 418. The latency service 418 can utilize timestamps on communications to and from the remote computing system 450 to determine if a communication has been received from the remote computing system 450 in time to be useful. For example, when a service of the internal computing system 410 requests feedback from remote computing system 450 on a time-sensitive process, the latency service 418 can determine if a response was timely received from remote computing system 450 as information can quickly become too stale to be actionable. When the latency service 418 determines that a response has not been received within a threshold, the latency service 418 can enable other systems of autonomous vehicle 402 or a passenger to make necessary decisions or to provide the needed feedback.

The internal computing system 410 can also include a user interface service 420 that can communicate with cabin system 438 in order to provide information or receive information to a human co-pilot or human passenger. In some embodiments, a human co-pilot or human passenger may be required to evaluate and override a constraint from constraint service 414, or the human co-pilot or human passenger may wish to provide an instruction to the autonomous vehicle 402 regarding destinations, requested routes, or other requested operations.

As described above, the remote computing system 450 is configured to send/receive a signal from the autonomous vehicle 402 regarding reporting data for training and evaluating machine learning algorithms, requesting assistance from remoting computing system or a human operator via the remote computing system 450, software service updates, ridesharing pickup and drop off instructions, etc.

The remote computing system 450 includes an analysis service 452 that is configured to receive data from autonomous vehicle 402 and analyze the data to train or evaluate machine learning algorithms for operating the autonomous vehicle 402. The analysis service 452 can also perform analysis pertaining to data associated with one or more errors or constraints reported by autonomous vehicle 402.

The remote computing system 450 can also include a user interface service 454 configured to present metrics, video, pictures, sounds reported from the autonomous vehicle 402 to an operator of remote computing system 450. User interface service 454 can further receive input instructions from an operator that can be sent to the autonomous vehicle 402.

The remote computing system 450 can also include an instruction service 456 for sending instructions regarding the operation of the autonomous vehicle 402. For example, in response to an output of the analysis service 452 or user interface service 454, instructions service 456 can prepare instructions to one or more services of the autonomous vehicle 402 or a co-pilot or passenger of the autonomous vehicle 402.

The remote computing system 450 can also include a rideshare service 458 configured to interact with ridesharing applications 470 operating on (potential) passenger computing devices. The rideshare service 458 can receive requests to be picked up or dropped off from passenger ridesharing app 470 and can dispatch autonomous vehicle 402 for the trip. The rideshare service 458 can also act as an intermediary between the ridesharing app 470 and the autonomous vehicle wherein a passenger might provide instructions to the autonomous vehicle 402 to go around an obstacle, change routes, honk the horn, etc.

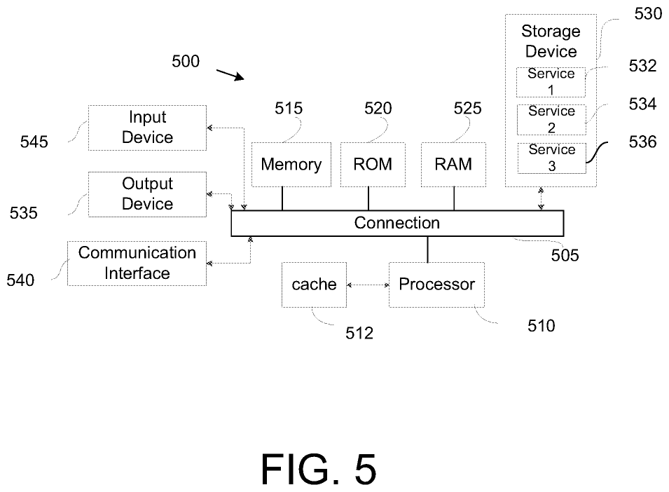

FIG. 5 shows an example of computing system 500, which can be for example any computing device making up radar sensor 200, internal computing system 410, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A radar sensor comprising:
at least one memory; and
at least one processor coupled to the at least one memory, the at least one processor configured to:
receive a radar signal, wherein the radar signal comprises radar data and message data;
disaggregate the radar data and the message data using a heterodyne mixer; and
provide the radar data to a radar signal processor via a waveform correlator.

2. The radar sensor of claim 1, wherein the message data is encoded using a Vehicle-to-Everything (V2X) communication protocol.

3. The radar sensor of claim 1, wherein the at least one processor is further configured to:
filter the radar data through a radar waveform bandpass filter.

4. The radar sensor of claim 1, wherein the at least one processor is further configured to:
filter the message data through a communication baseband bandpass filter.

5. The radar sensor of claim 1, wherein the at least one processor is further configured to:
decode the message data through a communication signal decoder.

6. The radar sensor of claim 1, wherein the radar signal includes an allocated amount of bandwidth that is dynamically determined by a speed of a vehicle sending the radar signal.

7. The radar sensor of claim 1, wherein the radar signal is received on an automotive radar radio frequency (RF) band.

8. A method comprising:
receiving a radar signal, wherein the radar signal comprises radar data and message data;
disaggregating the radar data and the message data using a heterodyne mixer; and
providing the radar data to a radar signal processor via a waveform correlator.

9. The method of claim 8, wherein the message data is encoded using a Vehicle-to-Everything (V2X) communication protocol.

10. The method of claim 8, further comprising:
filtering the radar data through a radar waveform bandpass filter.

11. The method of claim 8, further comprising:
filtering the message data through a communication baseband bandpass filter.

12. The method of claim 8, further comprising:
decoding the message data through a communication signal decoder.

13. The method of claim 8, wherein the radar signal includes an allocated amount of bandwidth that is dynamically determined by a speed of a vehicle sending the radar signal.

14. The method of claim 8, wherein the radar signal is received on an automotive radar radio frequency (RF) band.

15. A non-transitory computer readable medium comprising instructions, the instructions, when executed by a computing system, cause the computing system to:
receive a radar signal, wherein the radar signal comprises radar data and message data;
disaggregate the radar data and the message data using a heterodyne mixer; and
provide the radar data to a radar signal processor via a waveform correlator.

16. The non-transitory computer readable medium of claim 15, the message data is encoded using a Vehicle-to-Everything (V2X) communication protocol.

17. The non-transitory computer readable medium of claim 15, wherein the non-transitory computer readable medium further comprises instructions that, when executed by the computing system, cause the computing system to:
filter the radar data through a radar waveform bandpass filter.

18. The non-transitory computer readable medium of claim 15, wherein the non-transitory computer readable medium further comprises instructions that, when executed by the computing system, cause the computing system to:
filter the message data through a communication baseband bandpass filter.

19. The non-transitory computer readable medium of claim 15, wherein the non-transitory computer readable medium further comprises instructions that, when executed by the computing system, cause the computing system to:
decode the message data through a communication signal decoder.

20. The non-transitory computer readable medium of claim 15, the radar signal includes an allocated amount of bandwidth that is dynamically determined by a speed of a vehicle sending the radar signal.
